(19) United States
(12) Patent Application Publication
(10) Pub. No.: US 2026/0285041 A1
(43) Pub. Date: Sep. 24, 2026

(54) LIQUID EJECTION HEAD AND INKJET PRINTER

(71) Applicant: RISO Technologies Corporation, Tokyo (JP)

(72) Inventors: Daichi SAKAMOTO, Mishima Shizuoka (JP); Taiki GOTO, Mishima Shizuoka (JP); Noboru NITTA, Mishima Shizuoka (JP); Shuhei YOKOYAMA, Mishima Shizuoka (JP); Shinichiro HIDA, Mishima Shizuoka (JP); Ryutaro KUSUNOKI, Mishima Shizuoka (JP); Masashi SHIMOSATO, Mishima Shizuoka (JP)

(21) Appl. No.: 19/449,388

(22) Filed: Jan. 14, 2026

(30) Foreign Application Priority Data
Mar. 24, 2025 (JP) 2025-049031

(51) Int. Cl. B41J 2/14

(52) U.S. Cl. CPC B41J 2/14274; B41J 2/1433; B41J 2002/14419

(57) ABSTRACT

A liquid ejection head includes a nozzle plate including a plurality of nozzles through which a liquid is ejected, the nozzles being arranged in a first direction, a plurality of pressure chambers arranged in the first direction and each communicating with a corresponding one of the nozzles, a first common liquid chamber including: a first portion that extends in the first direction and communicates with each of the pressure chambers, and a second portion that is connected to an end of the first portion in the first direction, extends in a second direction orthogonal to the first direction, and is disposed in line with a row of the pressure chambers; and a first damper in the second portion of the first common liquid chamber.

### CROSS-REFERENCE TO RELATED APPLICATION

This application is based upon and claims the benefit of priority from Japanese Patent Application No. 2025-049031, filed on Mar. 24, 2025, the entire contents of which are incorporated herein by reference.

### FIELD

Embodiments described herein relate generally to a liquid ejection head and an inkjet printer.

### BACKGROUND

A liquid ejection head that supplies a predetermined amount of liquid to a predetermined position is known. The liquid ejection head is mounted in, for example, an inkjet printer, a 3D printer, or a dispensing device. The inkjet printer ejects droplets of ink from an inkjet head to form an image or the like on a surface of a recording medium. The 3D printer ejects droplets of a shaping material from a shaping material ejection head and cures the droplets to form a three-dimensional object. The dispensing device ejects droplets of a sample and supplies a predetermined amount of the droplets to a plurality of containers or the like.

The liquid ejection head includes a plurality of ejection channels for ejecting a liquid. Each ejection channel includes a nozzle that ejects a liquid, a pressure chamber that communicates with the nozzle, and an actuator that changes a volume of the pressure chamber. The liquid ejection head selects at least one ejection channel for ejecting the liquid from the plurality of ejection channels, and drives the actuator of the selected ejection channel to eject the liquid.

As a method for supplying a liquid to the liquid ejection head, a circulation supply method for circulating a liquid between a liquid tank and the liquid ejection head is adopted. In this method, if a circulation flow rate inside the head is smaller than a total ejection flow rate when the liquid is ejected from a plurality of nozzles, a water hammer phenomenon occurs, which may affect the stability of the meniscus of the liquid in the nozzle necessary for stable ejection. As a countermeasure, a damper is provided in a common liquid chamber communicating with the pressure chambers to buffer pressure fluctuations, but the resulting damper effect is insufficient.

### BRIEF DESCRIPTION OF THE DRAWINGS

FIG. 1 is a schematic diagram of an inkjet printer including inkjet heads according to a first embodiment.

FIG. 2 is a perspective view of the inkjet head.

FIG. 3 is a partially enlarged cross-sectional view of a head unit.

FIG. 4 is a partially enlarged cross-sectional view of the head unit.

FIG. 5 is a partially enlarged plan view of the head unit.

FIG. 6 is a partially enlarged cross-sectional view of the head unit.

FIG. 7 is a diagram illustrating a result of simulating a pressure fluctuation

FIG. 8 is a diagram illustrating a result of simulating a pressure fluctuation.

FIG. 9 is a diagram illustrating a result of simulating a pressure fluctuation.

FIG. 10 is a partially enlarged cross-sectional view of a head unit of an inkjet head according to a second embodiment.

### DETAILED DESCRIPTION

A liquid ejection head and an inkjet printer capable of buffering a pressure fluctuation in a head with a damper and performing stable ejection is provided.

In general, according to an embodiment, a liquid ejection head comprises a nozzle plate including a plurality of nozzles through which a liquid is ejected, the nozzles being arranged in a first direction; a plurality of pressure chambers arranged in the first direction and each communicating with a corresponding one of the nozzles; a first common liquid chamber including: a first portion that extends in the first direction and communicates with each of the pressure chambers, and a second portion that is connected to an end of the first portion in the first direction, extends in a second direction orthogonal to the first direction, and is disposed in line with a row of the pressure chambers; and a first damper in the second portion of the first common liquid chamber.

Hereinafter, a liquid ejection head according to embodiments will be described in detail with reference to the accompanying drawings. In the drawings, the same components are denoted by the same reference numerals.

### First Embodiment

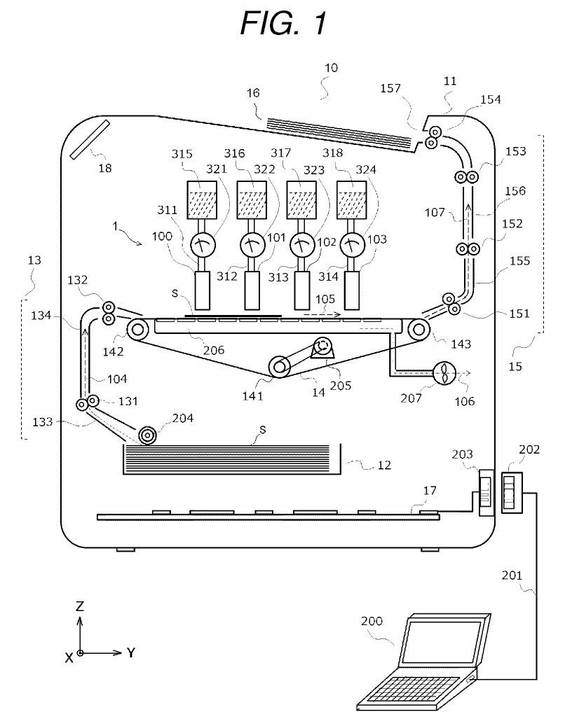

An inkjet printer 10 that prints an image on a recording medium will be described as an example of an image forming apparatus on which a liquid ejection head according to a first embodiment is mounted. FIG. 1 shows a schematic diagram of the inkjet printer 10. In the inkjet printer 10, a cassette 12 which accommodates a sheet S, which is an example of the recording medium, an upstream conveyance path 13 for the sheet S, a conveyance belt 14 which conveys the sheet S taken out of the cassette 12, a plurality of inkjet heads 100 to 103 which eject droplets of ink toward the sheet S on the conveyance belt 14, a downstream conveyance path 15 for the sheet S, a discharge tray 16, and a control board 17 are disposed inside a housing 11. An operation unit 18, which is a user interface, is disposed on an upper side of the housing 11.

Image data to be printed on the sheet S is generated by, for example, a computer 200 which is an externally connected device. The image data generated by the computer 200 is sent to the control board 17 of the inkjet printer 10 through a cable 201 and connectors 202 and 203.

A pickup roller 204 supplies the sheets S one by one from the cassette 12 to the upstream conveyance path 13. The upstream conveyance path 13 includes feed roller pairs 131 and 132 and sheet guide plates 133 and 134. The sheet S is fed to an upper surface of the conveyance belt 14 via the upstream conveyance path 13. An arrow 104 in the drawing indicates a conveyance path of the sheet S from the cassette 12 to the conveyance belt 14.

The conveyance belt 14 is a mesh-shaped endless belt having a large number of through holes formed in a surface thereof. Three rollers including a drive roller 141 and driven rollers 142 and 143 rotatably support the conveyance belt 14. A motor 205 rotates the conveyance belt 14 by rotating the drive roller 141. Reference numeral 105 in the drawing denotes the rotation direction of the conveyance belt 14. A negative pressure container 206 is disposed on a back surface side of the conveyance belt 14. The negative pressure container 206 is connected to a pressure reducing fan 207. The fan 207 creates a negative pressure inside the negative pressure container 206 by forming an airflow, and causes the sheet S to be adsorbed and held on the upper surface of the conveyance belt 14. Reference numeral 106 in the drawing denotes a flow of the airflow.

The inkjet heads 100 to 103 as an example of the liquid ejection head are disposed so as to face the sheet S adsorbed and held on the conveyance belt 14 with a slight gap of, for example, 1 mm therebetween. The inkjet heads 100 to 103 separately eject droplets of ink toward the sheet S. The inkjet heads 100 to 103 print an image when the sheet S passes therebelow. The inkjet heads 100 to 103 have the same structure except for different colors of the ink to be ejected. The colors of the ink are, for example, cyan, magenta, yellow, and black.

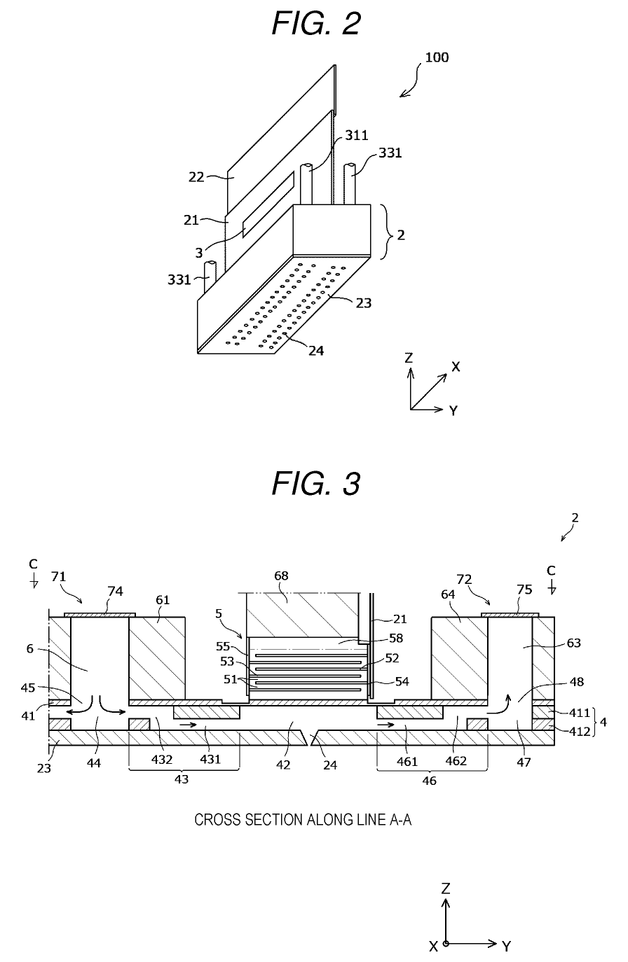

The inkjet heads 100 to 103 are respectively connected to ink tanks 315 to 318 and ink supply pressure adjustment devices 321 to 324 via ink supply paths 311 to 314. During standby, respective one of the ink supply pressure adjustment devices 321 to 324 adjusts a pressure in respective one of the inkjet heads 100 to 103 to a negative pressure with respect to the atmospheric pressure, for example, -1.2 kPa, such that the ink does not leak from nozzles 24 (see FIG. 2) of the inkjet heads 100 to 103. The ink in respective one of the ink tanks 315 to 318 is supplied by being circulated between respective one of the inkjet heads 100 to 103 and respective one of the ink tanks 315 to 318 by respective one of the ink supply pressure adjustment devices 321 to 324.

After the image formation, the sheet S is fed from the conveyance belt 14 to the downstream conveyance path 15. The downstream conveyance path 15 includes feed roller pairs 151, 152, 153, and 154 and sheet guide plates 155 and 156 that define a conveyance path for the sheet S. The sheet S is fed through a discharge port 157 to the discharge tray 16 via the downstream conveyance path 15. An arrow 107 in the drawing indicates the conveyance path for the sheet S.

Next, a configuration of the inkjet heads 100 to 103 will be described. Hereinafter, the inkjet head 100 will be described with reference to FIGS. 2 to 6, and the inkjet heads 101 to 103 also have the same structure as the inkjet head 100.

As shown in FIG. 2, the inkjet head 100 includes a head unit 2. The head unit 2 is connected to a flexible printed wiring board 21. The flexible printed wiring board 21 is connected to a printed circuit board 22.

The head unit 2 includes a nozzle plate 23. The nozzles 24 of respective ejection channels that eject ink are arranged along a first direction of the nozzle plate 23, for example, an X direction. A nozzle density is set within a range of, for example, 150 dpi to 1,200 dpi. The nozzles 24 are provided in four rows in a second direction, for example, a Y direction. An internal configuration of the ink circulation type head unit 2 will be described later, and the four rows of nozzles 24 in one group share an ink circulation system path in a set of two rows. Therefore, the ink supply path 311 and an ink collection path 331 are provided in two sets. The ink supply path 311 and the ink collection path 331 are provided as a pair at both ends of the head unit 2 in the X direction. The head unit 2 is connected to the ink supply pressure adjustment device 321 via the ink supply path 311 and the ink collection path 331. However, the arrangement of the nozzles 24 is not limited to four rows, and the number of rows may be increased or decreased.

A drive integrated circuit (IC) 3 (hereinafter, referred to as a drive IC) is mounted on the flexible printed wiring board 21. The drive IC 3 serving as a controller for the inkjet head 100 temporarily stores print data transmitted from the control board 17, including a central processing unit (CPU) serving as a controller for the inkjet printer 10, via the printed circuit board 22, and applies a drive signal to each ejection channel so as to eject ink at a predetermined timing.

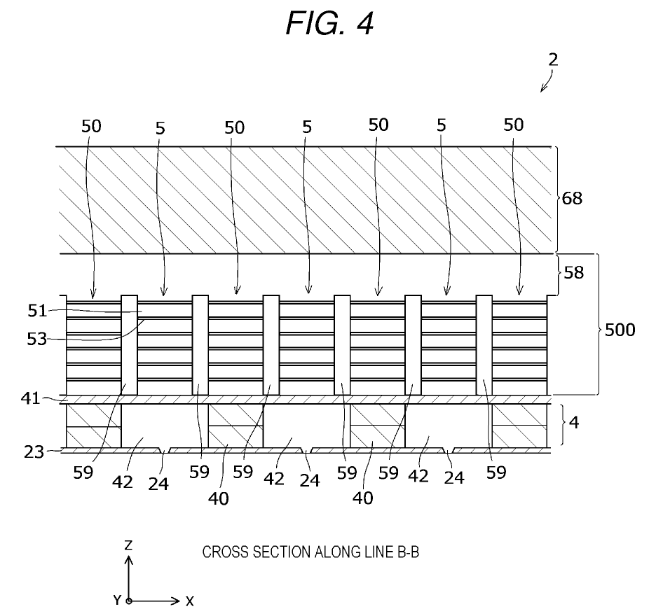

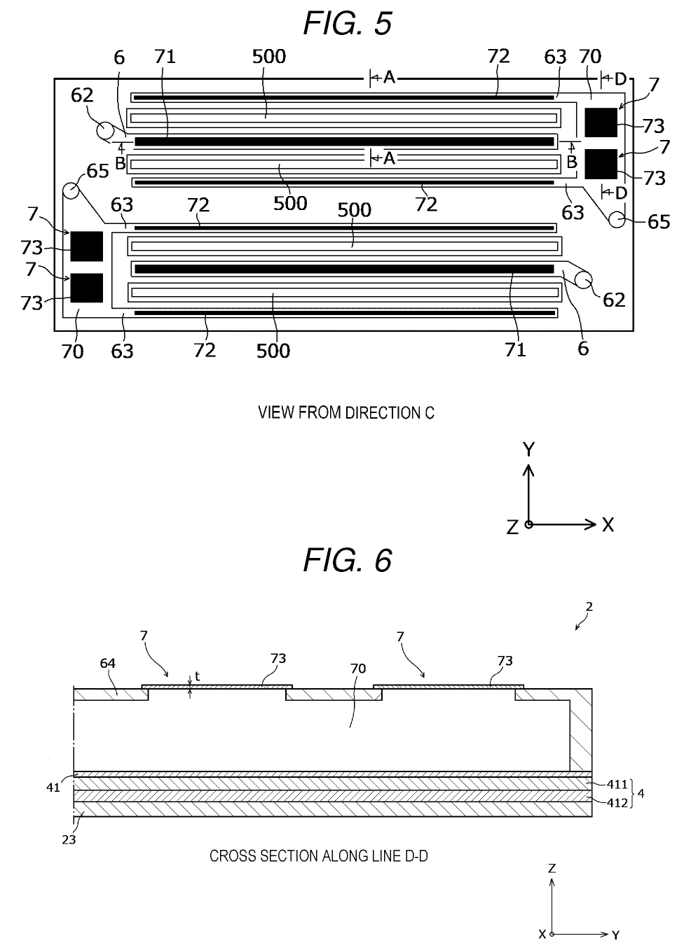

FIGS. 3 to 6 are cross-sectional views and the like of the head unit 2. FIG. 3 is a cross-sectional view taken along a line A-A in FIG. 5. FIG. 4 is a cross-sectional view taken along a line B-B in FIG. 5. FIG. 5 is a view in the direction of an arrow C in FIG. 3. FIG. 6 is a cross-sectional view taken along a line D-D in FIG. 5. The nozzle plate 23 is bonded to one surface of a flow path plate 4. The nozzle plate 23 is a rectangular plate formed of a resin such as a polyimide or a metal such as stainless steel. A diaphragm 41 is bonded to one surface of the flow path plate 4 on a side opposite to the nozzle plate 23. The diaphragm 41 has flexibility to be deformed when an external force is applied. The diaphragm 41 is a rectangular plate formed of, for example, a flexible polyimide film or metal.

The flow path plate 4 has, for example, a configuration in which two plates 411 and 412 each having an opening, a groove, or the like are laminated in a Z direction. The flow path plate 4 is formed with a plurality of pressure chambers 42 in respective ejection channels. The pressure chambers 42 are arranged at positions of the respective nozzles 24 and separately communicate with the nozzles 24. As an example, the pressure chamber 42 is formed by forming a rectangular opening penetrating a third direction, for example, the Z direction, in the flow path plate 4 (411 and 412) and closing openings on both sides in the Z direction with the nozzle plate 23 and the diaphragm 41, thereby forming a space to be filled with ink. The pressure chamber 42 is formed in a groove shape along, for example, the Y direction.

In the ink circulation type head, one end (ink supply side) of the pressure chamber 42 in the Y direction communicates with a supply-side common liquid chamber 6 via a resistance flow path portion 43 and an ink introduction portion 44 formed in the flow path plate 4 and an ink supply port 45 formed in the diaphragm 41. As an example, the supply-side common liquid chamber 6 is formed in a frame 61 bonded to one surface of the diaphragm 41. The supply-side common liquid chamber 6 is not limited to this, and may be formed in the flow path plate 4. The supply-side common liquid chamber 6 is an ink supply manifold formed along the arrangement direction (X direction) of the pressure chambers 42 and communicating with each pressure chamber 42. An ink supply port 62 that supplies ink to the supply-side common liquid chamber 6 is provided on one end side in the arrangement direction of the plurality of pressure chambers 42, that is, on one end side in the X direction in the shown example. The ink supply port 62 is connected to the ink supply path 311. The ink supply port 62 is also referred to as the liquid supply port.

The other end (ink collection side) of the pressure chamber 42 in the Y direction communicates with a collection-side common liquid chamber 63 via a resistance flow path portion 46 and an ink discharge portion 47 formed in the flow path plate 4 and an ink discharge port 48 formed in the diaphragm 41. As an example, the collection-side common liquid chamber 63 is formed in a frame 64 bonded to one surface of the diaphragm 41. The collection-side common liquid chamber 63 is not limited to this, and may be formed in the flow path plate 4. The collection-side common liquid chamber 63 is an ink collection manifold formed along the arrangement direction (X direction) of the pressure chambers 42 and communicating with each pressure chamber 42. An ink collection port 65 that discharges the ink from the collection-side common liquid chamber 63 to the outside of the head unit 2 is provided on the other end side in the arrangement direction of the plurality of pressure chambers 42, that is, on the other end side in the X direction in the shown example. The ink collection port 65 is connected to the ink collection path 331. The ink collection port 65 is also referred to as the liquid collection port.

The resistance flow path portion 43 on the ink supply side includes, for example, a portion 431 formed to be narrower than a width of the pressure chamber 42 in the X direction to reduce a flow path cross section and to have a flow path resistance, and a portion 432 having a changed flow direction from the plate 411 to the plate 412 to have a flow path resistance. Similarly, the resistance flow path portion 46 on the ink collection side includes, for example, a portion 461 formed to be narrower than the width of the pressure chamber 42 in the X direction to reduce a flow path cross section and to have a flow path resistance, and a portion 462 having a changed flow direction from the plate 411 to the plate 412 to have a flow path resistance.

As described above, the four rows of nozzles 24 in one group arranged in the nozzle plate 23 share the ink circulation system path in a set of two rows. The supply-side common liquid chamber 6 is shared by two rows of pressure chambers 42 communicating with the respective nozzles 24. Therefore, one supply-side common liquid chamber 6 is disposed between the two rows of pressure chambers 42, and a width in the Y direction is made larger than that of the collection-side common liquid chamber 63 to increase a volume by a shared amount. Two collection-side common liquid chambers 63 communicating with the pressure chambers 42 of each row are disposed on a side opposite to the supply-side common liquid chamber 6 with the pressure chambers 42 of each row interposed therebetween.

The other end side of the collection-side common liquid chamber 63, that is, an end portion on an ink collection port 65 side in the X direction, is expanded in a direction (Y direction) orthogonal to the arrangement direction (X direction) of the pressure chambers 42 to form an expanded common liquid chamber 70 along rows of the pressure chambers 42. As shown in FIG. 1, when printing is performed by arranging the plurality of inkjet heads 100 to 103 in the inkjet printer 10, printing accuracy deteriorates as a width of the sheet S in a conveyance direction (Y direction) increases. Therefore, by forming the expanded common liquid chamber 70 in the same row as the pressure chamber 42, a width of the head unit 2 in the Y direction is not increased. In the example in FIG. 5, two collection-side common liquid chambers 63 share the expanded common liquid chamber 70. The ink collection port 65 communicates with the expanded common liquid chamber 70.

One or more dampers 7 for buffering a pressure fluctuation in the head unit 2 are provided in the expanded common liquid chamber 70. Dampers 71 and 72 may also be provided in the supply-side common liquid chamber 6 and the collection-side common liquid chamber 63. However, only one of the damper 71 in the supply-side common liquid chamber 6 and the damper 72 in the collection-side common liquid chamber 63 may be provided.

An example of the damper is a membrane type pressure damper. The damper 7 in the expanded common liquid chamber 70 has, for example, a configuration in which two openings are formed in an upper portion of the expanded common liquid chamber 70 and the two openings are respectively sealed with two flexible thin films 73. The flexible thin film 73 can be bent against pressure vibration or the like propagating in the head unit 2, to buffer the pressure fluctuation. The damper 7 has a rectangular opening and is sealed with the thin film 73 having a rectangular shape similar to the opening. The damper shape can be a square. This is because, in the case of a rectangular shape, a damper effect is proportional to a fifth power of a short side and a first power of a long side, which is dominated by the short side, and thus a square where the short side and the long side are equal in length is the most efficient. As an example of a size of the damper 7 having a square shape, it has a width of 3 mm in the X direction and a length of 3 mm in the Y direction. Similarly, since the short side and the long side are equal in length also in a circular shape, for example, a circular shape having a diameter of 3 mm may be used instead of the rectangular shape. In addition, a polygonal shape where the short side and the long side are equal in length may be used, but in consideration of ease of production, the rectangular shape or the circular shape is preferred. The thin film 73 that seals the opening is a film formed of a resin such as a polyimide. For example, the thin film 73 is a polyimide film having a Young's modulus E of 9.12 GPa and a thickness of 5 μm or less.

In the example in FIG. 5, two collection-side common liquid chambers 63 share the expanded common liquid chamber 70, and two dampers 7 are provided corresponding to the respective collection-side common liquid chambers 63. However, embodiments of this disclosure are not limited to this, and the number of dampers 7 in the expanded common liquid chamber 70 may be increased or decreased.

The damper 71 in the supply-side common liquid chamber 6 and the damper 72 in the collection-side common liquid chamber 63 are membrane type dampers. The damper 71 in the supply-side common liquid chamber 6 has, for example, a configuration in which an elongated opening along a longitudinal direction (X direction) is formed in an upper portion of the supply-side common liquid chamber 6 and the opening is sealed with one flexible strip-shaped thin film 74. The damper 71 is formed to have a length corresponding to the pressure chambers 42 on at least both ends. Similarly, the damper 72 in the collection-side common liquid chamber 63 also has, for example, a configuration in which an elongated opening along the longitudinal direction (X direction) is formed in an upper portion of the collection-side common liquid chamber 63 and the opening is sealed with one flexible strip-shaped thin film 75. The thin films 74 and 75 that seal the opening are films formed of a resin such as a polyimide. For example, the thin films 74 and 75 are polyimide films having a Young's modulus E of 3.4 GPa and a thickness of 25 μm or less. As an example, the damper 71 in the supply-side common liquid chamber 6 and the damper 72 in the collection-side common liquid chamber 63 have a width of 4 mm or more in the Y direction.

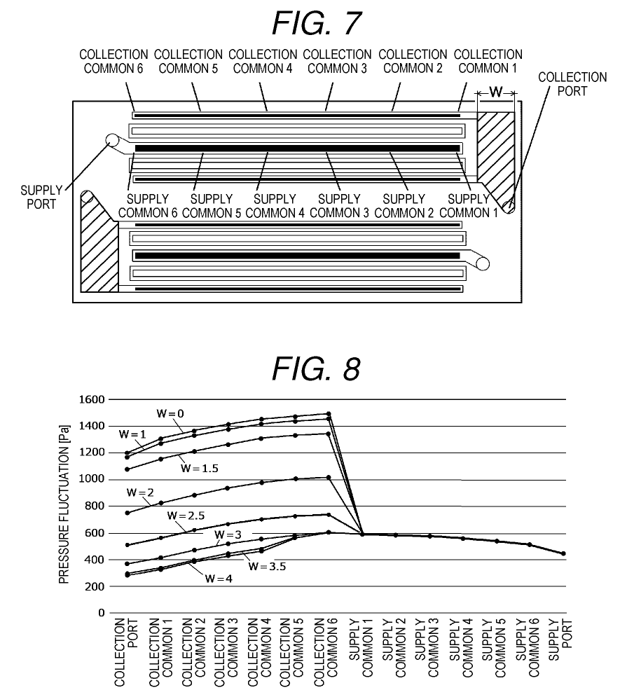

FIGS. 7 to 9 each show a result of simulating a pressure fluctuation when a width W (expansion width) of the damper 7 in the expanded common liquid chamber 70 in the X direction and a thickness t of the thin film 73 as parameters are changed. FIG. 8 is a graph showing the result of the pressure fluctuation when simulation is performed using an entire hatched portion in FIG. 7 as a damper and the width W in the X direction is changed to 0 mm (no damper), 1 mm, 1.5 mm, 2 mm, 2.5 mm, 3 mm, 3.5 mm, and 4 mm. A vertical axis in the graph represents a pressure fluctuation P [Pa], and each plotted point on a horizontal axis in the graph represents a value of the pressure fluctuation at each observation point shown in FIG. 7. In the simulation, the thin film 73 is a polyimide film having a Young's modulus E of 9.12 GPa and a thickness t of 5 μm as calculation conditions, and a finite element method is performed based on a structure of the head unit 2.

As shown in FIG. 8, when W = 0 mm (no damper), there is a portion where the pressure fluctuation is more than 1,400 Pa at maximum. With respect to this, by providing the damper 7 in the expanded common liquid chamber 70, the pressure fluctuation can be alleviated. That is, it is effective as a water hammer countermeasure. In particular, the width W in a range of 3 mm to 4 mm is effective. In particular, 3 mm is preferred. This is because the supply (IN) side and the collection (OUT) side are substantially symmetrical. Since the supply (IN) side does not have a parameter such as the width W and has the same structure, the result of the pressure fluctuation in each simulation is the same.

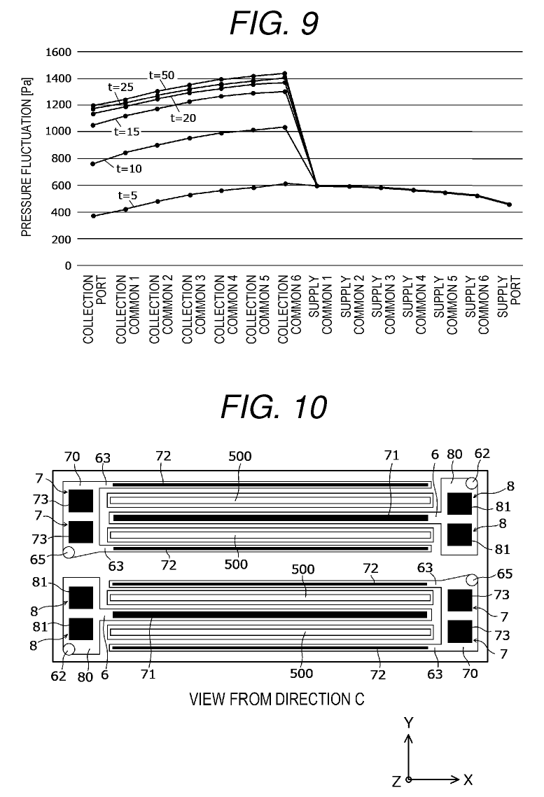

FIG. 9 is a graph showing the result of the pressure fluctuation when simulation is similarly performed and the thickness t of the polyimide film is changed to 5 μm, 10 μm, 15 μm, 20 μm, 25 μm, and 50 μm. The width W is 3 mm, which results in a good result in the simulation in FIG. 8. As shown in FIG. 9, as the thickness t of the polyimide film decreases, an effect of alleviating the pressure fluctuation is increased, which is effective as the water hammer countermeasure. For example, the thickness t is 5 μm. This is because the supply (IN) side and the collection (OUT) side are substantially symmetrical.

Referring back to FIG. 3, an actuator to be driven when ejecting ink will be described. A piezoelectric actuator 5 is disposed on one surface of the diaphragm 41 on a side opposite to each pressure chamber 42. The piezoelectric actuators 5 in respective ejection channels are arranged at positions facing the pressure chambers 42 with the diaphragm 41 interposed therebetween. The piezoelectric actuator 5 and the diaphragm 41 are bonded to each other by, for example, an adhesive. The piezoelectric actuator 5 is fixed by bonding, to a support member 68, one surface thereof opposite to the diaphragm 41 in the Z direction. In particular, as shown in FIG. 3, the piezoelectric actuator 5 is a laminated piezoelectric actuator formed by alternately laminating a piezoelectric body 51 such as a piezo element, a first internal electrode 52, and a second internal electrode 53 in layers. The first internal electrode 52 and the second internal electrode 53 are conductive films formed on main surfaces of the piezoelectric body 51. The first internal electrode 52 is formed up to one end surface of the piezoelectric actuator 5 in the Y direction, and is connected to a first external electrode 54 formed on the one end surface. The second internal electrode 53 is formed up to the other end surface of the piezoelectric actuator 5 in the Y direction, and is connected to a second external electrode 55 formed on the other end surface.

A dummy layer 58 is made of the same material as the piezoelectric body 51. The dummy layer 58 is not provided with an internal electrode and is not deformed since an electric field is not applied thereto. The dummy layer 58 serves as a base for fixing the piezoelectric actuator 5 to the support member 68 (see FIG. 4), or serves as a polishing allowance for polishing to improve accuracy during and after assembly. In particular, as shown in FIG. 4, pillars 50 may be disposed between the piezoelectric actuators 5 in respective ejection channels via grooves 59. The pillar 50 may be formed of a dummy actuator formed in the same manner as the driving piezoelectric actuator 5. The pillar 50 is disposed at, for example, a position corresponding to a partition wall 40 between adjacent pressure chambers 42. The pillar 50 may be formed of another member instead of the dummy actuator. The piezoelectric actuators 5 and the pillars 50 form an integral actuator block 500 through the dummy layer 58 (see FIG. 5).

The piezoelectric body 51 is formed of a lead-containing piezoelectric material such as lead zirconate titanate (PZT) or a lead-free piezoelectric material such as potassium sodium niobate. The first internal electrode 52 and the second internal electrode 53 are formed of a conductive material that can be fired, such as silver palladium. The first external electrode 54 and the second external electrode 55 are formed of Ni, Cr, Au, or the like by a known method such as plating or sputtering.

The first external electrodes 54 of the piezoelectric actuators 5 are connected to individual wiring of the flexible printed wiring board 21. The second external electrodes 55 of the piezoelectric actuators 5 are commonly connected to common wiring (not shown), and are connected to a ground (GND) via, for example, the flexible printed wiring board 21. In a state where a ground potential is applied to the second external electrode 55 on a common terminal side, the drive IC 3 applies a drive voltage to the first external electrode 54 on an individual terminal side. Accordingly, the piezoelectric actuator 5 is deformed (expanded or contracted) in the Z direction by an inverse piezoelectric action, and the volume of the pressure chamber 42 can be changed by bending the diaphragm 41. The drive IC 3 generates a signal of a drive waveform by combining a plurality of voltages (for example, 20 V, 10 V, and 0 V), and controls the volume and the pressure of the pressure chamber 42 to eject the ink from the nozzle 24.

Next, an example of operations of the inkjet head 100 having the above-described configuration will be described. The flow paths of the head unit 2 of the inkjet head 100 and the pressure chambers 42 are filled with ink in advance. Then, for example, when a power source of the inkjet printer 10 is turned on or a sleep state is canceled, the ink supply pressure adjustment device 321 is activated to circulate the ink between the inkjet head 100 and the ink tank 315. At this time, a temperature of the ink is adjusted to a predetermined temperature by a temperature adjuster (not shown) such as a heater. A predetermined circulation flow rate of the ink is, for example, 2 ml/min to 20 ml/min. The predetermined temperature is selected from, for example, a range of 20°C to 50°C.

When the circulation of the ink is started, the ink flowing from the ink supply port 62 flows into the supply-side common liquid chamber 6 in the head unit 2. Then, the ink is supplied from the supply-side common liquid chamber 6, which is an ink supply manifold, to respective pressure chambers 42 via the resistance flow path portion 43 of respective ejection channels. The ink that passed through respective pressure chambers 42 merges in the collection-side common liquid chamber 63, which is an ink collection manifold, via the resistance flow path portion 46, and the merged ink is discharged from the ink collection port 65.

The drive IC 3 selects a channel for ejecting ink and applies a drive voltage to the piezoelectric actuator 5. The piezoelectric actuator 5 to which the drive voltage is applied expands or contracts in the Z direction by the inverse piezoelectric action, and changes the volume of the pressure chamber 42 to eject the ink from the nozzle 24. Which channel's piezoelectric actuator 5 is to be driven is determined based on print data. The piezoelectric actuators 5 in all ejection channels may be driven. Therefore, if the ink circulation flow rate in the head unit 2 is smaller than a total ejection flow rate when the ink is ejected from a plurality of ejection channels, the influence of a fluctuation of an ink flow rate flowing through the collection-side common liquid chamber 63 before and after the ejection is large, and a rapid pressure fluctuation may occur, but in the present embodiment, the pressure fluctuation can be buffered by forming the expanded common liquid chamber 70 and providing the damper 7. Therefore, it is effective to provide the damper 7 in the expanded common liquid chamber 70 in the vicinity of the ink collection port 65 where the pressure fluctuation is large (since the fluctuations of all the ejection channels are accumulated).

### Second Embodiment

Next, the inkjet head 100 according to a second embodiment will be described. The inkjet head 100 according to the second embodiment has the same configuration as that of the first embodiment except that a damper 8 is also provided on the ink supply side. Therefore, the same components as those in the first embodiment are denoted by the same reference numerals, and detailed description thereof will be omitted.

As shown in FIG. 10, in the inkjet head 100 according to the second embodiment, the other end side of the supply-side common liquid chamber 6, that is, the end portion on the ink supply port 62 side in the X direction, is expanded in the direction (Y direction) orthogonal to the arrangement direction (X direction) of the pressure chambers 42 to form an expanded common liquid chamber 80 along rows of the pressure chambers 42. In this case, by forming the expanded common liquid chamber 80 in the same row as the pressure chamber 42, the width of the head unit 2 in the Y direction is also not increased. In FIG. 10, the other end side of the supply-side common liquid chamber 6 is expanded to both sides in the Y direction to form the expanded common liquid chamber 80. The ink supply port 62 communicates with the expanded common liquid chamber 80.

One or more dampers 8 are provided in the expanded common liquid chamber 80. An example of the damper 8 is a membrane type pressure damper. The damper 8 has, for example, a configuration in which two openings are formed in an upper portion of the expanded common liquid chamber 80 and the two openings are respectively sealed with two flexible thin films 81. The damper 8 has a rectangular opening and is sealed with the thin film 81 having a rectangular shape similar to the opening. The damper shape can be a square. As an example of a size of the damper 8 having a square shape, it has a width of 3 mm in the X direction and a length of 3 mm in the Y direction. Instead of the rectangular shape, for example, a circular shape having a diameter of 3 mm may be used. In addition, a polygonal shape where the short side and the long side are equal in length may be used. The thin film 81 that seals the opening is a film formed of a resin such as a polyimide. For example, the thin film 81 is a polyimide film having a Young's modulus E of 9.12 GPa and a thickness of 5 μm or less.

As described above, when the expanded common liquid chamber 70 is formed and the damper 7 is provided on the ink collection side, the pressure fluctuation can be buffered. The effect is also checked by simulation. In the present embodiment, by further forming the expanded common liquid chamber 80 and providing the damper 8 on the ink supply side, the pressure fluctuation can be buffered also on the ink supply side. In the example in FIG. 10, both the expanded common liquid chamber 80 and the damper 8 on the ink supply side and the expanded common liquid chamber 70 and the damper 7 on the ink collection side are provided, but only the expanded common liquid chamber 80 and the damper 8 on the ink supply side may be provided. In addition, when the expanded common liquid chamber 80 and the damper 8 on the ink supply side are provided, the pressure fluctuation can be buffered even if the widths of the supply-side common liquid chamber 6 and the damper 71 in the Y direction are reduced.

As described above, according to any of the above-described embodiments, it is possible to provide the inkjet head 100 capable of buffering the pressure fluctuation in the head unit 2 with the dampers 7 and 8, and as a result, capable of performing stable ejection.

The piezoelectric actuator 5 is not limited to a laminated type in which a plurality of piezoelectric bodies 51 are laminated. The piezoelectric actuator 5 may be a piezoelectric actuator having a single layer. The operation of the actuator when the drive voltage is applied is not limited to longitudinal vibration. Further, embodiments of this disclosure are not limited to a drop-on-demand piezoelectric method, and may be applied to a continuous method.

In the above-described embodiments, the inkjet head 100 of the inkjet printer 10 is described as an example of a liquid ejection device, but the liquid ejection device may be a shaping material ejection head of a 3D printer or a sample ejection head of a dispensing device.

The embodiments have been presented by way of example and are not intended to limit the scope of the exemplary embodiments. These novel embodiments can be implemented in various other forms, and various omissions, substitutions, and modifications can be made without departing from the gist of the exemplary embodiments. These embodiments and modifications thereof are included in the scope and the gist of the exemplary embodiments, and are included in a scope of the exemplary embodiments disclosed in the claims and equivalents thereof.

What is claimed is:

1. A liquid ejection head comprising:
a nozzle plate including a plurality of nozzles through which a liquid is ejected, the nozzles being arranged in a first direction;
a plurality of pressure chambers arranged in the first direction and each communicating with a corresponding one of the nozzles;
a first common liquid chamber including:
a first portion that extends in the first direction and communicates with each of the pressure chambers, and
a second portion that is connected to an end of the first portion in the first direction, extends in a second direction orthogonal to the first direction, and is disposed in line with a row of the pressure chambers; and
a first damper in the second portion of the first common liquid chamber.

2. The liquid ejection head according to claim 1, wherein
the liquid that passed through the pressure chambers flows into the first portion of the first common liquid chamber.

3. The liquid ejection head according to claim 1, wherein
the liquid flows from the first portion of the first common liquid chamber into the pressure chambers.

4. The liquid ejection head according to claim 1, further comprising:
a second common liquid chamber including:
a first portion that extends in the first direction and communicates with each of the pressure chambers, and
a second portion that is connected to an end of the first portion in the first direction, extends in the second direction, and is disposed in line with the row of the pressure chambers; and
a second damper in the second portion of the second common liquid chamber.

5. The liquid ejection head according to claim 4, wherein
the liquid flows from the first portion of the second common liquid chamber into each of the pressure chambers, and then flows into the first portion of the first common liquid chamber.

6. The liquid ejection head according to claim 1, further comprising:
a third damper in the first portion of the first common liquid chamber, the third damper extending in the first direction.

7. The liquid ejection head according to claim 1, wherein
the first damper is a membrane type pressure damper.

8. The liquid ejection head according to claim 7, wherein
the second portion of the first common liquid chamber has an opening, and
the first damper includes a film that seals the opening.

9. The liquid ejection head according to claim 8, wherein
the opening has a square shape.

10. The liquid ejection head according to claim 8, wherein
the film is a polyimide film having a thickness of 5 μm or less.

11. An inkjet printer comprising:
an inkjet head configured to eject ink and including:
a nozzle plate including a plurality of nozzles through which the ink is ejected, the nozzles being arranged in a first direction,
a plurality of pressure chambers arranged in the first direction and each communicating with a corresponding one of the nozzles,
a first common liquid chamber including:
a first portion that extends in the first direction and communicates with each of the pressure chambers, and
a second portion that is connected to an end of the first portion in the first direction, extends in a second direction orthogonal to the first direction, and is disposed in line with a row of the pressure chambers, and
a first damper in the second portion of the first common liquid chamber;
a conveyance belt configured to convey a recording medium in the second direction; and
a controller configured to control the inkjet head to eject the ink onto the recording medium as the recording medium is conveyed by the conveyance belt.

12. The inkjet printer according to claim 11, wherein
the ink that passed through the pressure chambers flows into the first portion of the first common liquid chamber.

13. The inkjet printer according to claim 11, wherein
the ink flows from the first portion of the first common liquid chamber into the pressure chambers.

14. The inkjet printer according to claim 11, wherein
the inkjet head further includes:
a second common liquid chamber including:
a first portion that extends in the first direction and communicates with each of the pressure chambers, and
a second portion that is connected to an end of the first portion in the first direction, extends in the second direction, and is disposed in line with the row of the pressure chambers, and
a second damper in the second portion of the second common liquid chamber.

15. The inkjet printer according to claim 14, wherein
the liquid flows from the first portion of the second common liquid chamber into each of the pressure chambers, and then flows into the first portion of the first common liquid chamber.

16. The inkjet printer according to claim 11, wherein
the inkjet head further includes a third damper in the first portion of the first common liquid chamber, the third damper extending in the first direction.

17. The inkjet printer according to claim 11, wherein
the first damper is a membrane type pressure damper.

18. The inkjet printer according to claim 17, wherein
the second portion of the first common liquid chamber has an opening, and
the first damper includes a film that seals the opening.

19. The inkjet printer according to claim 18, wherein
the opening has a square shape.

20. The inkjet printer according to claim 18, wherein
the film is a polyimide film having a thickness of 5 μm or less.
